(19) United States
(12) Patent Application Publication
(10) Pub. No.: US 2024/0007835 A1
(43) Pub. Date: Jan. 4, 2024

(54) ULTRA LOW POWER WIRELESS SENSOR MODULE SELECTIVELY CONNECTABLE TO VARIOUS SENSORS

(71) Applicant: NODETALKS CORP., Pohang-si (KR)

(72) Inventor: Kyoung Sik MOON, Pohang-si (KR)

(73) Assignee: NODETALKS CORP., Pohang-si (KR)

(21) Appl. No.: 18/039,674

(22) PCT Filed: Dec. 11, 2020
(86) PCT No.: PCT/KR2020/018123

§ 371 Date: May 31, 2023

(30) Foreign Application Priority Data
Dec. 3, 2020 (KR) 10-2020-0167264

(51) Int. Cl. H04W 4/80

(52) U.S. Cl. CPC H04W 4/80

(57) ABSTRACT

A wireless sensor module is disclosed. The wireless sensor module comprises: a plurality of terminals which can be connected to a plurality of sensors, respectively; a sensor interface integrated circuit (IC) for driving a sensor connected to at least one from among the plurality of terminals; and a control IC for controlling the sensor interface IC to drive the connected sensor and acquiring sensing data of the connected sensor. The control IC transmits the sensing data to at least one external device by means of Bluetooth low energy (BLE).

### TECHNICAL FIELD

The present disclosure relates to a wireless sensor module, and, more particularly, to an ultra-low-power wireless sensor module that is connected to various sensors and operates based on the Bluetooth Low Energy (BLE) communication.

### BACKGROUND

As the IoT system develops, sensor modules or sensor nodes based on various wireless communication methods such as LTE, LoRa, and WiFi have been developed.

However, when using the above-described communication methods, there are problems that a sensor module consumes a lot of energy and that, due to the weight and volume of the sensor module, there are limitations in finding a location to install the sensor module.

Recently, the Bluetooth Low Energy (BLE) communication method falling within low power Bluetooth communication has been developed, which leads to reduced power consumption and miniaturization of sensor modules.

However, it is necessary to further consider an ultra-low-power sensor module of which the power consumption can be more effectively reduced when it operates based on the BLE communication.

### SUMMARY

The present disclosure provides an ultra-low-power wireless sensor module of which power consumption can be greatly reduced when transmitting sensing data based on wireless communication.

The present disclosure provides a wireless sensor module capable of collecting sensing data suitable for a place and situation by being freely connected to various sensors in a detachable manner.

The present disclosure provides a wireless sensor module capable of selectively collecting and transmitting sensing data while minimizing power consumption in normal times by using the BLE method and/or a wake-up IC.

The purposes of the present disclosure are not limited to the above-mentioned purpose, and other purposes and advantages of the present disclosure not mentioned above can be understood in the following description and can be more clearly understood in the embodiments of the present disclosure. Furthermore, it will be readily apparent that the purposes and advantages of the present disclosure can be realized by means and combinations thereof in the claims.

The wireless sensor module according to an embodiment of the present disclosure includes: a plurality of terminals that can be respectively connected to a plurality of sensors; a sensor interface integrated circuit (IC) for driving a sensor connected to at least one of the plurality of terminals; and a control IC that controls the sensor interface IC to drive the connected sensor and obtains sensing data of the connected sensor. The control IC transmits the obtained sensing data to at least one external device based on the BLE method.

The control IC transmits the sensing data to the external device while operating in one of an advertising mode and a beacon mode.

In the meantime, the wireless sensor module further includes a wake-up IC that receives a wake-up signal from the external device while the control IC is in standby. In this case, the wake-up IC makes the control IC in standby operate when the wake-up signal is received from the external device, and the control IC controls the sensor interface IC to drive the connected sensor as it is put in an operating mode and transmits sensing data of the connected sensor to the external device.

Here, the control IC determines whether there is a change in how one or more sensors connected to the plurality of terminals are combined after the control IC is put in a standby mode compared to how they were combined before it is put in a standby mode, and transmits information on the changed combination of the connected sensors to the external device when there is a change in how the sensors are combined.

The wake-up IC transmits an advertising signal including information about the connected sensor to the external device while the control IC is in standby and makes the control IC in standby operate when the wake-up signal is received from the external device. In this case, the control IC controls the sensor interface IC to drive the connected sensor as it is put in an operating mode and transmits sensing data of the connected sensor to the external device.

Meanwhile, the wireless sensor module further includes a battery connected to at least one energy harvesting module for collecting energy. The battery supplies the energy collected by the energy harvesting module to at least one of the control IC, the sensor interface IC, and the wake-up IC.

In the meantime, the plurality of terminals are connected to analog sensors. In this case, the sensor interface IC converts an output of an analog sensor connected to at least one of the plurality of terminals into a digital form and inputs the converted output to the control IC. In addition, the control IC is directly connected to at least one terminal that can be connected to a digital sensor.

The wireless sensor module according to the present disclosure may vary power consumption depending on whether a sensor is connected and/or whether it is paired with an external device, thereby cutting down power consumption.

The wireless sensor module including the wake-up IC according to an embodiment of the present disclosure may activate the control IC only when a wake-up signal is received, thereby cutting down power consumption.

### BRIEF DESCRIPTION OF THE DRAWINGS

FIG. 1 is a block diagram for describing a circuit of a wireless sensor module according to an embodiment of the present disclosure.

FIG. 2A is a view of an algorithm for describing the operation of the wireless sensor module according to an embodiment of the present disclosure.

FIG. 2B is a view of an algorithm for describing the operation of the wireless sensor module according to an embodiment of the present disclosure.

FIG. 3 is a block diagram for describing a circuit of the wireless sensor module including a wake-up IC according to an embodiment of the present disclosure.

FIG. 4A is a view of an algorithm for describing the operation of the wireless sensor module including the wake-up IC according to an embodiment of the present disclosure.

FIG. 4B is a view of an algorithm for describing the operation of the wireless sensor module including the wake-up IC according to an embodiment of the present disclosure.

FIG. 5 is a view of an algorithm for describing the operation of the wireless sensor module including the wake-up IC according to an embodiment of the present disclosure.

FIG. 6 is a block diagram for describing a circuit of the wireless sensor module including a plurality of sensor interface ICs according to an embodiment of the present disclosure.

FIG. 7 is a block diagram for describing a circuit of the wireless sensor module receiving energy from an energy harvesting module according to an embodiment of the present disclosure.

FIG. 8 is a block diagram for describing a circuit of the wireless sensor module that can be connected to both an analog sensor and a digital sensor according to an embodiment of the present disclosure.

FIG. 9 is a view for describing components of a wireless sensor network according to an embodiment of the present disclosure.

### DETAILED DESCRIPTION

Prior to a detailed description of the present disclosure, the method of describing the present specification and drawings will be described.

First, terms used in this specification and claims were selected from general terms in consideration of functions in the various embodiments of the present disclosure. However, these terms may vary depending on the intention and legal or technical interpretation of a person having ordinary skills in the art, the emergence of new technologies, etc. In addition, some terms were arbitrarily selected by the applicant. These terms may be interpreted as the meanings defined in this specification, and, when there is no specific definition, they may be interpreted based on the overall content of this specification and common technical knowledge in the art.

Furthermore, the same reference numerals or symbols described in each drawing attached to this specification indicate parts or components that perform substantially the same function. For convenience of description and understanding, the same reference numerals or symbols are used in different embodiments. That is, even when components having the same reference numeral are shown in all of the plurality of drawings, the drawings do not represent one embodiment.

In addition, in the present specification and claims, terms including ordinal numbers such as “first” and “second” may be used to distinguish components. These ordinal numbers are used to distinguish the same or similar components from each other, and the meaning of the terms should not be limited by the use of these ordinal numbers. For example, the order of use or arrangement of components referred to by terms including such ordinal numbers should not be limited by the numbers. If necessary, each ordinal number may be used interchangeably.

In the present specification, expressions in the singular form may include the meaning of the plural form unless they clearly mean otherwise in the context. In the present disclosure, expressions such as “comprise” or “consist of” are intended to indicate that there exist features, numbers, steps, operations, components, parts, or combinations thereof described in the specification, and should not be understood to preclude the presence or addition of one or more other features, numbers, steps, operations, components, parts, or combinations thereof.

In the embodiments of the present disclosure, terms such as “module,” “unit,” and “part” are used to refer to components that perform at least one function or operation, and these components may be implemented in hardware or software or a combination of hardware and software. In addition, a plurality of “modules,” “units,” “parts”, etc. are integrated into at least one module or chip to be implemented as at least one processor unless each of them needs to be implemented as individual specific hardware.

Furthermore, in the embodiments of the present disclosure, when a part is said to be connected to another part, the parts may be directly connected to each other or indirectly connected to each other through another medium. In addition, a certain part is said to include a certain component, it means that the part may further include other components without excluding them unless otherwise specified.

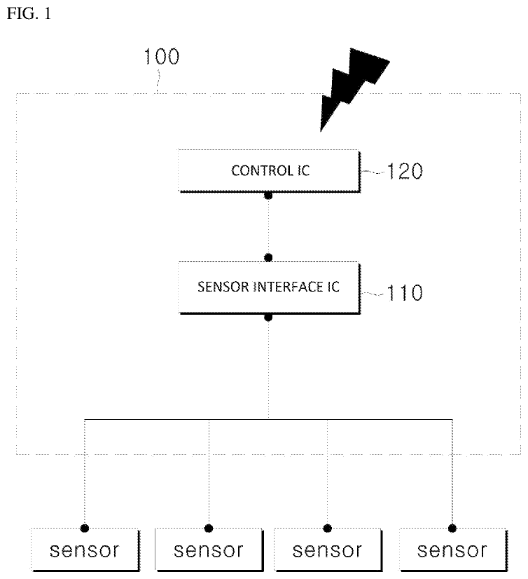

FIG. 1 is a block diagram for describing a circuit of a wireless sensor module according to an embodiment of the present disclosure.

Referring to FIG. 1, the wireless sensor module 100 may include a plurality of terminals to be connected to a plurality of sensors, a sensor interface integrated circuit (IC) 110 connected to the plurality of terminals, a control IC 120, etc.

Various types of sensors may be connected to each of the plurality of terminals. For example, sensors for measuring various factors such as gas concentration, temperature, humidity, illumination, fine dust concentration, wind direction, wind speed, rainfall, pH, flow rate, and pressure may be connected to each terminal. Here, the sensors may be designed to be detachably connected to each terminal.

Depending on the type of connected sensor, the wireless sensor module may be used for a range of purposes. For example, the wireless sensor module may operate as a sensor device constituting various IoT systems such as smart farms, smart factories, and smart cities.

The sensor interface IC 110 may consist of a circuit or chip for driving a sensor connected to at least one of the plurality of terminals.

The sensor interface IC 110 may control whether or not a sensor is driven, a driving cycle, etc. for each connected sensor.

In addition, the sensor interface IC 110 may convert the (analog) output of a connected sensor into a digital form and transmit it to the control IC 120.

The control IC 120 may consist of a circuit or a chip for controlling the sensor interface IC 110 to drive a connected sensor.

The control IC 120 may drive at least one sensor through the sensor interface IC 110 and obtain sensing data of the sensor.

The control IC 120 may include at least one circuit for communicating with at least one external device.

The control IC 120 may be connected to a sink node through various wireless communication schemes such as Bluetooth, Wi-Fi, LTE, and 5G.

For a representative example of reducing consumed power, the control IC 120 may transmit sensing data to at least one external device based on the Bluetooth Low Energy (BLE) method.

Here, the external device may be a relay device for receiving a Bluetooth signal from one or more wireless sensor modules. Alternatively, the external device may be a user's terminal for receiving a Bluetooth signal from one or more wireless sensor modules.

According to an embodiment of the present disclosure, the control IC 120 may include at least one processor and a communication unit.

The processor may be a component for overall controlling various components included in the wireless sensor module 100, such as the sensor interface IC 110 and the communication unit.

For example, the processor may be formed as a microprocessor and control each component in the wireless sensor module 100 using a serial interface commonly used in embedded systems such as UART, 12C, and SPI or other various protocols, etc.

The communication unit may be a component for communicating with at least one sink node, and correspond to a module or circuit for communicating with the sink node by the above-described various methods (e.g., BLE, WiFi, etc.). In addition, the communication unit may further include a circuit for performing wired or wireless communication with at least one gateway device.

Meanwhile, it is needless to say that an embodiment in which the wireless sensor module 100 further includes various components other than the components shown in FIG. 1 is also possible. For example, the wireless sensor module 100 may further include a wake-up IC 130, a battery 140, etc., which will be described below, and may also include at least one speaker, a buzzer, a vibration motor, a light emitting diode (LED), etc. for providing a signal or an alarm when a sensing value is out of a normal range.

Meanwhile, the control IC 120 according to an embodiment of the present disclosure may operate in one of an advertising mode and a beacon mode.

The advertising mode is a mode for performing pairing with at least one external device and transmitting sensing data by exchanging data with the paired external device one-to-one.

In the advertising mode, the control IC 120 may broadcast an advertising signal including information about a sensor connected to at least one terminal of the wireless sensor module 100.

Here, the information about a sensor may include identification information on the sensor, such as the type and the standard of the sensor.

The advertising signal may further include identification information on the wireless sensor module 100 in addition to the information about the connected sensor.

Then, when a signal in response to the broadcasted advertising signal is received from at least one external device, pairing (e.g., BLE connection) between the control IC 120 and the corresponding external device may be performed.

Here, the (response) signal received from the external device may include a pairing request, identification information on the external device, parameter information related to a connected sensor, etc.

The parameter information may include various information related to sensing to be performed, such as parameters that need to be sensed (e.g., gas concentration, temperature, humidity, etc.), sensing cycle, sensing period, normal range of sensing values, and abnormal range of sensing values.

The control IC 120 may perform pairing with an external device as a signal including a pairing request is received.

After the pairing, the control IC 120 may exchange data with the external device according to the BLE Attribute protocol.

In this case, the control IC 120 may transmit sensing data of a connected sensor to the paired external device.

For a specific example, the control IC 120 may select a parameter (e.g., temperature, humidity, gas concentration, etc.) that currently needs to be sensed according to parameter information included in a signal received from an external device, and may control the sensor interface IC 130 to drive only a selected sensor (capable of sensing the corresponding parameter) among one or more connected sensors.

In addition, the control IC 120 may transmit sensing data of a driven sensor to an external device. As such, when only sensors matching parameter information are driven, power consumption of the wireless sensor module 100 may be reduced.

In the advertising mode, the control IC 120 may also receive various control signals from an external device.

For example, a control signal for changing parameter information to be sensed, a control signal for changing the mode of the wireless sensor module 100, a control signal for controlling other functions of the wireless sensor module 100 (e.g., providing an alarm through a speaker or LED), etc. may be received.

The beacon mode is a mode for broadcasting sensing data so that at least one external device in the vicinity can receive it.

In the beacon mode, the control IC 120 may obtain sensing data of a connected sensor and repeatedly transmit the obtained sensing data to at least one external device in the vicinity.

Specifically, the control IC 120 may repeatedly broadcast a signal including sensing data and identification information (e.g., a unique identifier) on the wireless sensor module 100.

When there are a plurality of sensor nodes corresponding to each of a plurality of wireless sensor modules nearby, the sink node may distinguish the source of each signal (e.g., a sensor node that has transmitted sensing data) by identification information included in a signal received from each sensor node.

In the beacon mode, the control IC 120 may transmit sensing data of a sensor in a standard beacon format such as iBeacon, Eddystone, and ALT Beacon, which has been previously defined, or in an arbitrary format, and corresponding information may be checked using at least one external device operating as a beacon scanner. In this case, only an external device located within the transmission range of the wireless sensor module 100 can scan the sensing data.

In the beacon mode, the control IC 120 may not go through a separate connection process such as pairing with an external device. That is, sensing data broadcasted by the control IC 120 may be simultaneously checked by one or more external devices. However, sensing data may not be transmitted when the transmission period of the control IC 120 and the scan period of an external device do not match.

Meanwhile, the control IC 120 may identify a normal range of a sensing value of a connected sensor and determine whether the sensing value is out of the normal range. Here, the normal range of the sensing value may be preset for each sensor.

For example, the control IC 120 may obtain a sensing value in a preset first cycle and transmit it to an external device (e.g., an IDLE mode) when the sensing value of a sensor is within the normal range, and may obtain the sensing value in a second cycle shorter than the above-described first cycle and transmit it to the external device (e.g., a FAST mode) when the sensing value of the sensor is out of the normal range.

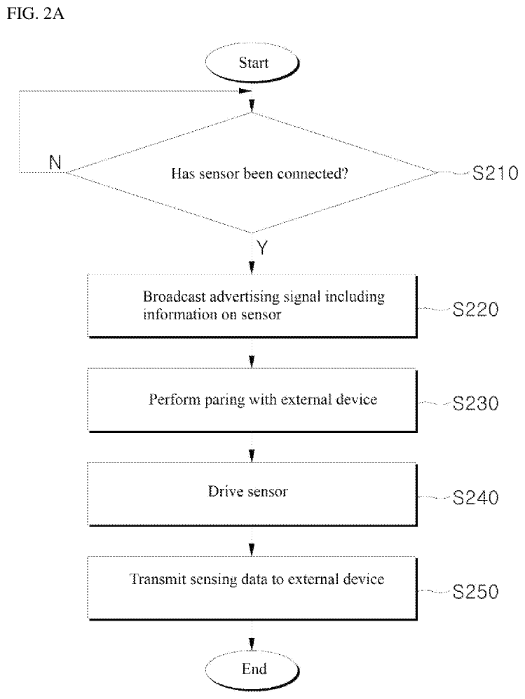

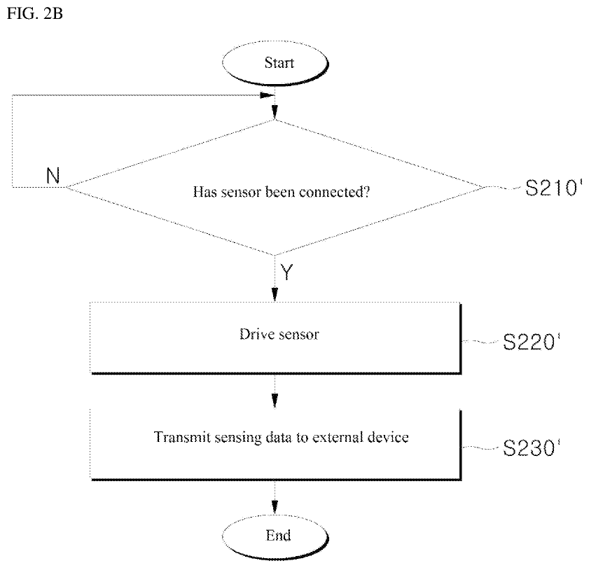

Hereinafter, examples of operations of the control IC 120 that transmits sensing data to an external device as a sensor is connected will be described with reference to FIGS. 2A and 2B.

FIG. 2A is a view of an algorithm for describing the operation of the wireless sensor module according to an embodiment of the present disclosure. In the algorithm shown in FIG. 2A, it is assumed that the control IC 120 operates in the advertising mode.

Referring to FIG. 2A, as at least one sensor is connected at S210—Y, the control IC 120 may broadcast an advertising signal including information about the sensor at S220.

Here, as a combination of connected sensors is changed, the control IC 120 may broadcast the advertising signal including the information about the changed combination of connected sensors.

For example, when a sensor that was not connected is additionally connected or at least one of previously connected sensors is removed, it may be identified that a combination of connected sensors has been changed.

In addition, as a signal of an external device in response to a broadcasted advertising signal is received, the control IC 120 may perform pairing with the external device at S230.

After the pairing has been performed, the control IC 120 may drive a sensor with the sensor interface IC 110 at S240.

In this case, the control IC 120 may selectively drive only a sensor matching parameter information included in a signal received from an external device among connected sensors.

Furthermore, the control IC 120 may transmit sensing data of a sensor to an external device at S250.

Meanwhile, FIG. 2B is a view of an algorithm for describing the operation of the wireless sensor module according to an embodiment of the present disclosure. In the algorithm shown in FIG. 2B, it is assumed that the control IC 120 operates in the beacon mode.

Referring to FIG. 2B, as at least one sensor is connected at S210′—Y, the control IC 120 may drive a connected sensor at S220′.

In addition, the control IC 120 may repeatedly transmit sensing data of the driven sensor to at least one external device in the vicinity at S230′. Specifically, the control IC 120 may repeatedly broadcast a signal including sensing data so that the nearby external device may obtain the sensing data through the signal.

Meanwhile, the wireless sensor module 100 according to an embodiment of the present disclosure may further include the wake-up IC that receives a wake-up signal from an external device during standby.

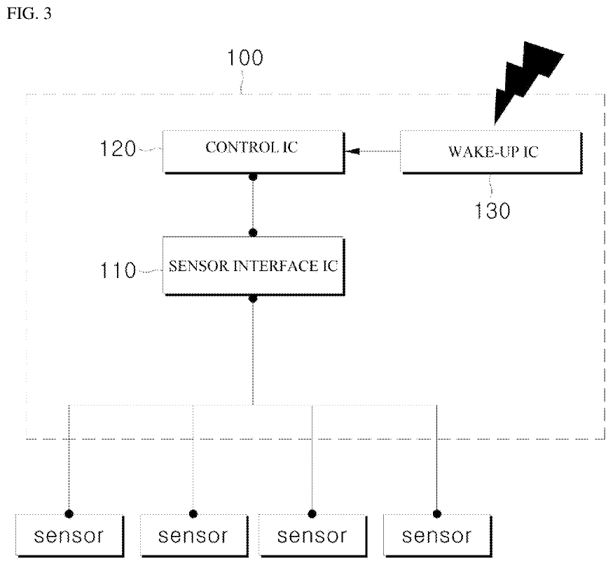

In this regard, FIG. 3 is a block diagram for describing a circuit of the wireless sensor module including the wake-up IC according to an embodiment of the present disclosure.

The wake-up IC 130 may receive a wake-up signal from at least one external device while the control IC 120 is in standby. In this case, the wake-up IC 130 may communicate with an external device at the same frequency as the control IC 120 (e.g., 2.4 GHz), but may also communicate with the external device at a different frequency and/or in a different communication method.

When a wake-up signal is received, the wake-up IC 130 may make the control IC 120 in standby operate, so that the control IC 120 may control the sensor interface IC 110 to drive a connected sensor and transmit sensing data of the connected sensor to an external device.

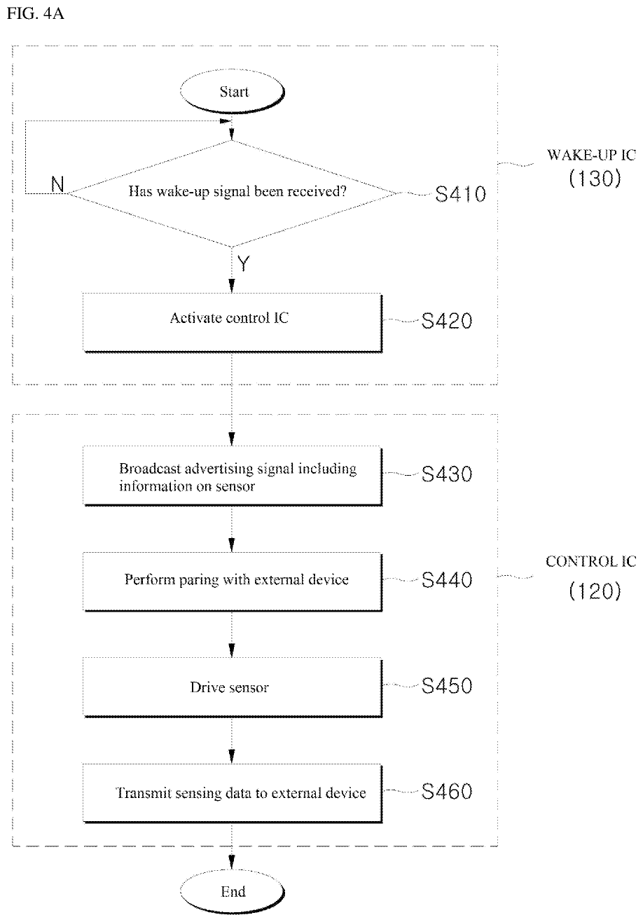

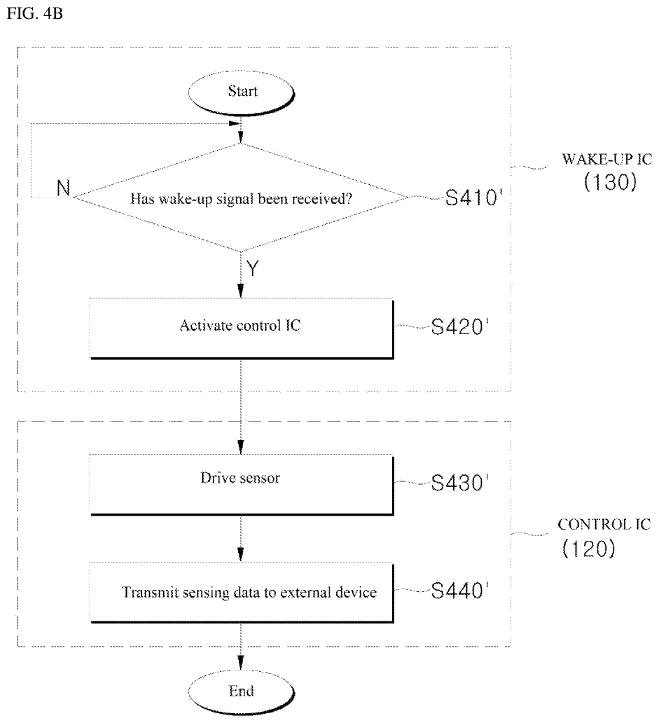

FIGS. 4A and 4B show algorithms for describing embodiments related to the operation of the wireless sensor module including the wake-up IC.

First, in the algorithm of FIG. 4A, it is assumed that the (activated) control IC 120 is designed to operate in the advertising mode.

Referring to FIG. 4A, as a wake-up signal is received from at least one external device at S410, the wake-up IC 130 may activate the control IC 120 at S420.

Specifically, the wake-up IC 130 may include a signal sensing circuit capable of sensing a wake-up signal of an external device using a minute current.

When a wake-up signal is sensed, the wake-up IC 130 may activate the control IC 120 in standby to make it operate.

When in standby, the control IC 120 may not consume power or operate in a super power saving mode. While the control IC 120 is in standby, the sensor interface IC 110 and a connected sensor may also be in standby (not consuming power or operating in a super power saving mode).

The control IC 120 that has been activated and is in an operation mode may broadcast an advertising signal including information on connected sensors at S430.

Then, when a signal in response to the advertising signal is received from an external device, the control IC 120 may perform pairing with the external device at S440. In this case, the signal received from the external device may include parameter information.

Meanwhile, the control IC 120 may determine whether there is a change in how one or more sensors connected to the plurality of terminals of the wireless sensor module 100 are combined after the control IC 120 is put in a standby mode compared to how they were combined before it is put in a standby mode. In other words, the control IC 120 may determine whether there is a difference between how the sensors connected the wireless sensor module 100 were combined before the control IC 120 is put in a standby mode and how they are combined after it is put in a standby mode.

Furthermore, when there has been a change in the combination of the connected sensors, the control IC 120 may transmit information about the changed combination of the connected sensors to an external device.

In this case, the information about the changed combination of the connected sensors may be included in an advertising signal broadcasted in step S430, or may be separately transmitted to the external device immediately after pairing.

After pairing has been performed according to the above-described process, the control IC 120 may drive a sensor using the sensor interface 110 at S450. In this case, the control IC 120 may control the sensor interface 110 to selectively drive only a sensor that matches parameter information included in a signal received from an external device.

Then, the control IC 120 may transmit sensing data of the driven sensor to the external device at S460.

Meanwhile, in the algorithm in FIG. 4B, it is assumed that the (activated) control IC 120 is designed to operate in the beacon mode.

Referring to FIG. 4B, when a wake-up signal is received from at least one external device at S410′, the wake-up IC 130 may activate the control IC 120 at S420′.

In this case, the activated control IC 120 may control the sensor interface IC 110 to drive a connected sensor at S430′ and repeatedly broadcast sensing data of the sensor at S440′. As a result, at least one external device in the vicinity may receive the sensing data.

As the wake-up IC 130 is used as mentioned above, a wake-up signal is received from an external device only when necessary to activate the control IC 120 and the sensor interface IC 110, so that power consumption of the wireless sensor module 100 may be reduced, which may lead to an increase in the use period of the wireless sensor module 100 and miniaturization thereof.

On the other hand, unlike the embodiments shown in FIGS. 4A and 4B described above, the wake-up IC 130 may not only receive a wake-up signal from an external device but also broadcast at least one signal to the outside.

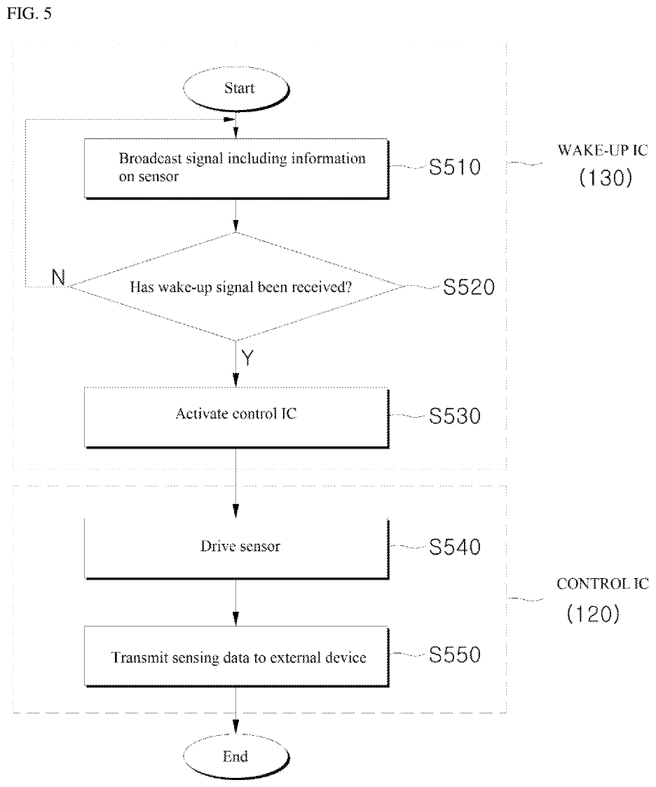

In this regard, FIG. 5 shows an algorithm for describing the operation of the wireless sensor module including the wake-up IC according to an embodiment of the present disclosure.

Referring to FIG. 5, the wake-up IC 130 may broadcast a signal including information about a sensor connected to the wireless sensor module 100 at S510. The broadcasted signal may include information about the type of the connected sensor, identification information thereof, etc.

In this case, the wake-up IC 130 may broadcast the signal with a relatively long cycle, and power consumption of the wake-up IC 130 may be relatively reduced by lengthening the cycle.

Here, the wake-up IC 130 may determine whether a combination of connected sensors has been changed while the control IC 120 is in standby. When the combination of the connected sensors is changed, the wake-up IC 130 may broadcast a signal including information about the changed combination of the connected sensors.

Subsequently, when a wake-up signal is received at S520, the wakeup IC 130 may activate the control IC 120 at S530.

Specifically, a nearby external device may identify a sensor connected to the wireless sensor module 100 using a signal broadcasted from the wake-up IC 130. In addition, a wake-up signal for activating the wireless sensor module 100 from the external device may be received by the wake-up IC 130.

As the wake-up signal is received, the activated control IC 130 may drive a connected sensor at S540.

In addition, the control IC 120 may transmit sensing data to at least one external device at S550.

Here, the control IC 120 may operate in the advertising mode or the beacon mode.

For example, when the control IC 120 operates in the advertising mode, the control IC 120 may broadcast an advertising signal to be paired with at least one external device.

In this case, the control IC 120 may transmit sensing data to the paired external device.

Here, the control IC 120 may identify a parameter that needs to be sensed using parameter information received from the paired external device.

In this case, the control IC 120 may control the sensor interface 110 to selectively drive only a sensor for sensing the identified parameter among connected sensors.

In addition, the control IC 120 may identify a sensing cycle and/or a sensing period using the parameter information received from the paired external device, and may transmit sensing data to the external device based on the identified sensing cycle and/or sensing period.

Furthermore, the control IC 120 may identify a normal range of a sensing value using the parameter information received from the paired external device, and may transmit sensing data at different intervals when a sensing value of a sensor is in the normal range and when it is not in the normal range.

For another example, the activated control IC 120 may operate in the beacon mode. In this case, the control IC 120 may transmit sensing data to at least one external device in the vicinity.

Here, when parameter information is included in a wake-up signal received by the wake-up IC 130, the control IC 120 operating in the beacon mode may drive at least one sensor according to the parameter information and broadcast sensing data to the outside.

Specifically, the control IC 120 may set parameters that need to be sensed, sensing cycle, sensing period, normal range of sensing values, etc. based on the parameter information included in the wake-up signal in order to drive at least one sensor and may broadcast sensing data to the outside.

Meanwhile, the control IC 120 may determine whether there is a change in how sensors connected to the wireless sensor module 100 are combined after the control IC 120 is put in a standby mode compared to how they were combined before it is put in a standby mode.

In this case, the control IC 120 may selectively drive only a sensor for sensing a parameter that needs to be sensed among the (connected) sensors in the changed combination.

As shown in FIG. 5, when the wake-up IC 130 broadcasts information about a (connected) sensor while the control IC 120 is inactive, even if an external device has never paired with the control IC 120, it may be possible that the external device identifies a sensor connected to the wireless sensor module 100 without directly communicating with the control IC 120.

In addition, even when it is changed how (connected) sensors are combined while the control IC 120 is in standby, there may be no problem because it may be possible that the external device identifies how currently connected (changed) sensors are combined using a signal broadcasted by the wake-up IC 130.

As such, an external device may selectively activate only the control IC of the wireless sensor module having the type of sensor that is required by transmitting a wake-up signal only to the wireless sensor module having the type of sensor that is required, which may lead to a reduction in the power consumption of all wireless sensor modules that can be connected to the external device, including the wireless sensor module 100.

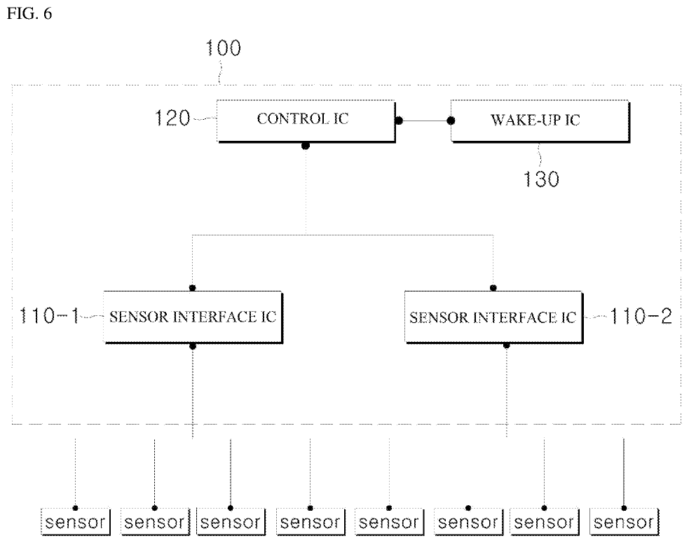

Meanwhile, FIG. 6 is a block diagram for describing a circuit of a wireless sensor module including a plurality of sensor interface ICs according to an embodiment of the present disclosure.

Referring to FIG. 6, the wireless sensor module 100 may include the plurality of sensor interfaces 110-1 and 110-2, and each sensor interface may drive various sensors.

In an embodiment, the control IC 120 activated by the wake-up IC 130 may identify sensors connected to each sensor interface.

In this case, the control IC 120 may identify a parameter that needs to be sensed based on parameter information received from an external device. In addition, the control IC 120 may selectively activate only a sensor interface IC connected to a sensor of the parameter that needs to be sensed among the plurality of sensor interface ICs 110-1, -2, . . . .

As a result, it may be possible to cut down power consumption of the plurality of sensor interface ICs 110-1, -2, . . . .

Meanwhile, although not shown in the above-mentioned drawings, the wireless sensor module 100 may include at least one battery for supplying power to each component.

The battery may receive energy in a wired or wireless manner from various energy sources such as at least one external battery, power generation device, and power plant/substation.

For example, the battery may be connected to at least one external energy harvesting module.

The energy harvesting module may be a solar power generation device, a wind power generation device, a geothermal power generation device, etc., but may also fall within various devices that collect energy using vibrations, radio waves, etc.

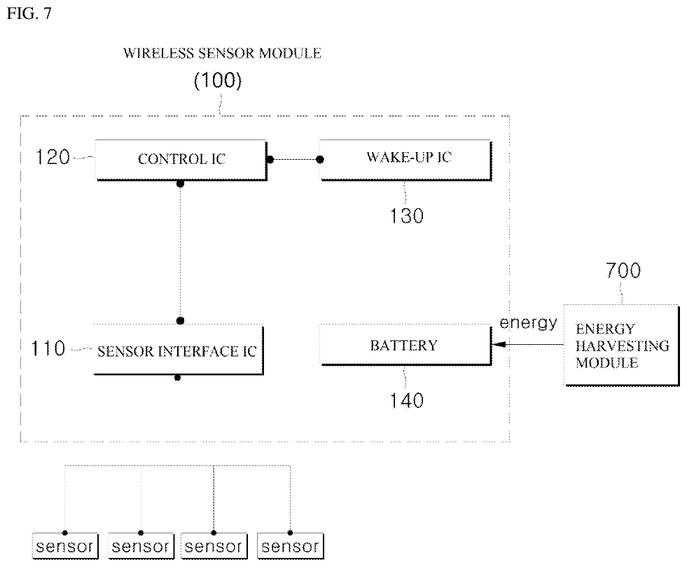

In this regard, FIG. 7 is a block diagram for describing a circuit of the wireless sensor module receiving energy from the energy harvesting module according to an embodiment of the present disclosure.

Referring to FIG. 7, the wireless sensor module 100 may include a battery 140 connected to the energy harvesting module 700.

The battery 140 may supply energy collected by the energy harvesting module 800 to at least one of the sensor interface IC 110, the control IC 120, and the wake-up IC 130.

In the meantime, the wireless sensor module according to an embodiment of the present disclosure may be connected to various types of sensors including analog sensors and digital sensors.

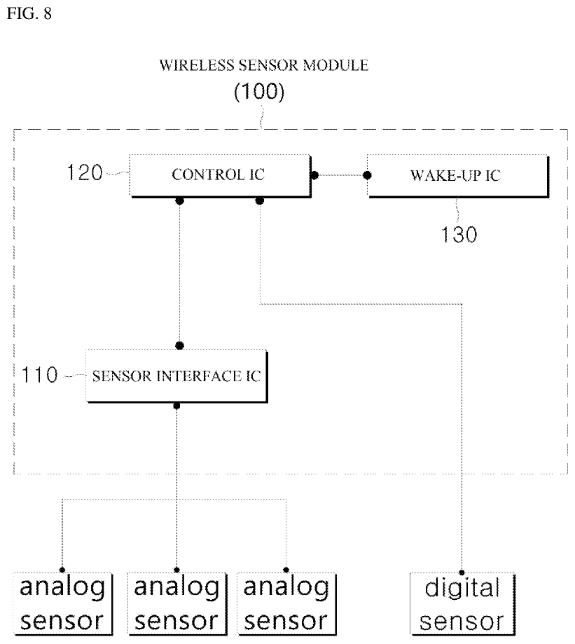

In this regard, FIG. 8 is a block diagram for describing a circuit of the wireless sensor module that can be connected to both an analog sensor and a digital sensor according to an embodiment of the present disclosure.

Referring to FIG. 8, analog sensors may be connected to the sensor interface IC 110, and the sensor interface IC 110 may convert the output of the analog sensors into a digital form and send it to the control IC 120.

To this end, the sensor interface IC 110 may include an analog-to-digital converter, but is not limited thereto.

Referring to FIG. 8, when at least one digital sensor is connected to a digital terminal of the wireless sensor module 100, the digital sensor may be directly connected to the control IC 120.

As a result, the control IC 120 may drive both an analog sensor and a digital sensor and obtain outputs of both the analog sensor and the digital sensor.

However, unlike the embodiment shown in FIG. 8, it is needless to say that an embodiment in which a digital sensor is directly connected to the sensor interface IC 110 is also possible.

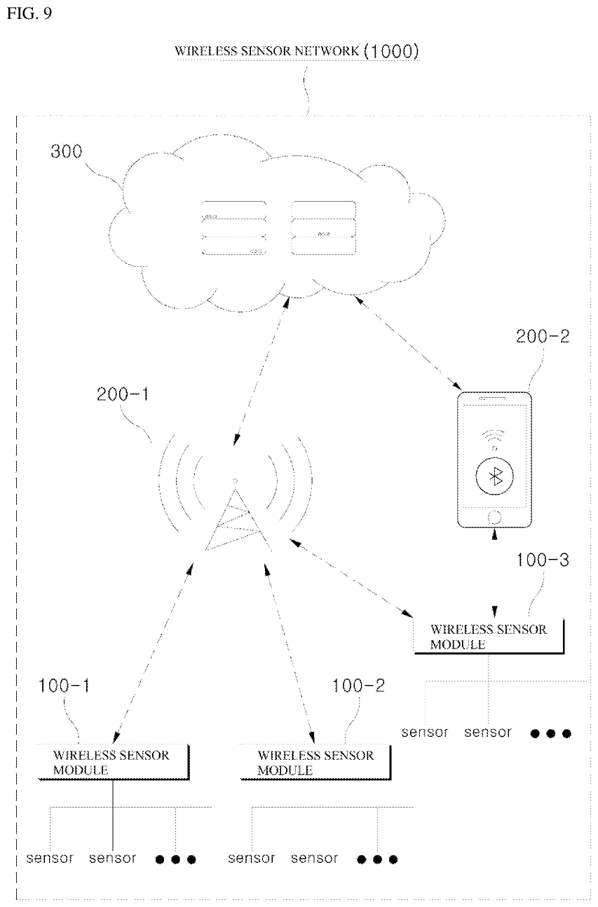

FIG. 9 is a view for describing components of a wireless sensor network according to an embodiment of the present disclosure.

Referring to FIG. 9, the wireless sensor network 1000 may include a plurality of wireless sensor modules 100-1, 2, and 3, a relay device 200-1, a user's terminal 200-2, a server 300, etc.

The wireless sensor network 1000 may correspond to an IoT network for various purposes such as a smart farm network, a smart factory network, a smart city network, and a home network.

For example, when the wireless sensor network 1000 is a smart farm network, each wireless sensor module may be connected to sensors for measuring various information (e.g., temperature, humidity, amount of sunlight, etc.) related to the growth environment of crops.

For example, when the wireless sensor network 1000 is a smart factory network, each wireless sensor module may be connected to sensors for measuring/acquiring/analyzing various process-related information (e.g., whether or not an error occurs, process speed, production volume, etc.).

For example, when the wireless sensor network 100 is a smart city network, each wireless sensor module may be connected to sensors for measuring/acquiring/analyzing various information related to city management (e.g., electricity/gas consumption, energy consumption of buildings, energy supply of power generation devices, indoor temperature/humidity, traffic volume, etc.).

Meanwhile, each of the wireless sensor modules 100-1, 2, and 3 shown in FIG. 9 may have the aforementioned components of the wireless sensor module 100 and perform the above-described operations of the wireless sensor module 100 by being connected to at least one sensor.

The relay device 200-1 may communicate with at least one wireless sensor module based on the BLE method.

The relay device 200-1 may receive sensing data by performing pairing with each wireless sensor module. In addition, the relay device 200-1 may transmit the received sensing data to the server 300. The relay device may access a network including the server 300 through at least one access point, gateway device, etc.

As a result, the server 300 may transmit the sensing data to various devices including the user's terminal 200-2.

The server 300 may be connected to the relay device 200-1 and/or the user's terminal 200-2 by a range of networks. The network may be a personal area network (PAN), a local area network (LAN), a wide area network (WAN), etc., depending on the area or scale, and may include an intranet, an extranet, the Internet, etc. depending on the openness of the network.

Each of the relay device 200-1 and the user's terminal 200-2 may be connected to a network of the server 300 by various wireless communication methods such as WiFi, LTE, and 5G, but are not limited thereto.

The user's terminal 200-2 may be implemented as a smart phone, a tablet PC, a remote-control device, etc. or as a wearable device such as a smart watch or smart glasses.

The user's terminal 200-2 may obtain sensing data by communicating with at least one wireless sensor module based on the BLE method. Alternatively, the user's terminal 200-2 may obtain sensing data by communicating with at least one wireless sensor module through the server 300 and/or the relay device 200-1.

In this case, the user's terminal 200-2 may provide sensing data upon a user's request. Alternatively, the user's terminal 200-2 may raise an alarm or warning signal about a sensing value when the sensing value is out of a preset normal range on an application, etc.

The user's terminal 200-2 may obtain sensing data for at least one parameter by driving at least one wireless sensor module upon a user's request.

For a specific example, it is assumed that a plurality of wireless sensor modules 100-1, 2, and 3 are installed in a house.

When a user's command to receive a sensing value of a real-time temperature in the house is received by the user's terminal 200-2, the user's terminal 200-2 may drive a wireless sensor module (e.g., 100-2) connected to a temperature sensor.

Here, the user's terminal 200-2 may transmit a wake-up signal to the wake-up IC of the wireless sensor module 100-2, and the wake-up signal may include parameter information related to temperature.

In this case, the control IC of the wireless sensor module 100-2 may be activated, and the control IC may drive only a sensor for measuring temperature among sensors connected to the wireless sensor module 100-2 and transmit a sensing value of the sensor to the user's terminal 200-2.

Meanwhile, when the user's terminal 200-2 is connected to the wireless sensor module 200-2 by the server 300 and the relay device 200-1, at the request of the user's terminal 200-2, the relay device 200-1 may transmit a wake-up signal to the wireless sensor module 100-2.

In this case, the relay device 200-1 may receive sensing data from the (activated) control IC of the wireless sensor module 100-2. In addition, the relay device 200-1 may transmit the received sensing data to the user's terminal 200-2 through the server 300.

Meanwhile, although not shown, it may be of course possible that the relay device 200-1 and the user's terminal 200-2 are directly connected base on Bluetooth, BLE, Wi-Fi, etc.

Meanwhile, the various embodiments described above may be implemented by combining at least two embodiments as long as they do not conflict with each other.

In addition, the various embodiments described above may be implemented in a recording medium readable by a computer or similar device using software, hardware, or a combination thereof.

When the embodiments described in the present disclosure are implemented in hardware, they may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions.

In some cases, the embodiments described in the present disclosure may be implemented by a processor itself. When the embodiments such as procedures and functions described in the present disclosure are implemented in software, they may be implemented by separate software modules. Each of the software modules described above may carry out one or more functions and operations described in the present disclosure.

On the other hand, computer instructions or computer programs for performing processing operations in the wireless sensor module 100 according to the various embodiments of the present disclosure described above may be stored in a non-transitory computer-readable medium. When such computer instructions or computer programs stored in a non-transitory computer-readable medium are executed by a processor of a specific device, they may enable the device to carry out processing operations in the wireless sensor module 100 according to the various embodiments of the present disclosure described above.

A non-transitory computer-readable medium refers to a medium that stores data semi-permanently and can be read by a device, not a medium that stores data for a short moment, such as a register, cache, or memory. Examples of the non-transitory computer-readable medium may include a CD, DVD, hard disk, Blu-ray disk, USB, memory card, ROM, etc.

Although the desirable embodiments of the present disclosure have been shown and described above, the present disclosure is not limited to the specific embodiments described above. It goes without saying that various modifications can be performed by a person having ordinary skills in the art within the scope of the gist of the present disclosure in the claims, and such modifications should not be understood separately from the technology or perspective of the present disclosure.

What is claimed is:

1. A wireless sensor module, comprising:
a plurality of terminals that can be respectively connected to a plurality of sensors;
a sensor interface integrated circuit (IC) for driving a sensor connected to at least one of the plurality of terminals; and
a control IC that controls the sensor interface IC to drive the connected sensor and obtains sensing data of the connected sensor,
wherein the control IC transmits the obtained sensing data to at least one external device based on the Bluetooth Low Energy (BLE) method.

2. The wireless sensor module of claim 1, wherein the control IC transmits the sensing data to the external device while operating in one of an advertising mode and a beacon mode.

3. The wireless sensor module of claim 1,
wherein the wireless sensor module further includes a wake-up IC that receives a wake-up signal from the external device while the control IC is in standby,
the wake-up IC makes the control IC in standby operate when the wake-up signal is received from the external device, and
the control IC controls the sensor interface IC to drive the connected sensor as it is put in an operating mode and transmits sensing data of the connected sensor to the external device.

4. The wireless sensor module of claim 3,
wherein the control IC determines whether there is a change in how one or more sensors connected to the plurality of terminals are combined after the control IC is put in a standby mode compared to how they were combined before it is put in a standby mode, and transmits information on the changed combination of the connected sensors to the external device when there is a change in how the sensors are combined.

5. The wireless sensor module of claim 3,
wherein the wake-up IC transmits an advertising signal including information about the connected sensor to the external device while the control IC is in standby and makes the control IC in standby operate when the wake-up signal is received from the external device, and
the control IC controls the sensor interface IC to drive the connected sensor as it is put in an operating mode and transmits sensing data of the connected sensor to the external device.

6. The wireless sensor module of claim 1,
wherein the wireless sensor module further includes a battery connected to at least one energy harvesting module for collecting energy, and
the battery supplies the energy collected by the energy harvesting module to at least one of the control IC, the sensor interface IC, and the wake-up IC.

7. The wireless sensor module of claim 1,
wherein the plurality of terminals are connected to analog sensors,
the sensor interface IC converts an output of an analog sensor connected to at least one of the plurality of terminals into a digital form and inputs the converted output to the control IC, and
the control IC is directly connected to at least one terminal that can be connected to a digital sensor.
